(19) United States
(12) Patent Application Publication
(10) Pub. No.: US 2013/0154351 A1
(43) Pub. Date: Jun. 20, 2013

(54) ELECTRICAL ARCHITECTURE WITH POWER OPTIMIZATION

(71) Applicants: Mark J. Seger, Rockford, IL (US); Massoud Vaziri, Redmond, WA (US)

(72) Inventors: Mark J. Seger, Rockford, IL (US); Massoud Vaziri, Redmond, WA (US)

(21) Appl. No.: 13/329,355

(22) Filed: Dec. 19, 2011

(51) Int. Cl. B60L 1/00; H02J 3/00

(52) U.S. Cl. 307/9.1; 307/29

(57) ABSTRACT

An electrical architecture includes at least one generator. A fast switching device connects the generator to a bus. A plurality of loads draw electrical power from the bus.

### BACKGROUND

This application relates to an electric architecture that optimizes the control of the supply of power from a generator to an electrical bus.

Aircraft are typically provided with gas turbine engines. The gas turbine engines power the aircraft, but are also provided with generators that generate electricity as the gas turbine engine is driven.

Electricity is supplied to buses on the aircraft from the generators. Electrical components on the aircraft draw power from those buses. The supply of power from the generator to the bus must be capable of addressing overload conditions, in addition to normal steady state load demands.

Presently, the generator is connected to the bus with a conventional power switching device that acts as a circuit breaker. These conventional power switching devices are generally mechanical, and require a relatively long period of time to open.

The generator must be sized for addressing not just steady state load demands, but it must also be capable of meeting fault clearing conditions. When there is a fault, the generator must supply sufficient power such that the other components within the overall architecture still do receive power, even given the fault.

As such, the generator is undesirably large. In addition, other associated components, such as switches, wires, etc., are also made larger to handle the larger potential fault clearing power supply conditions.

So-called solid state switching devices are known, but typically have not been utilized for connecting a generator to the bus. Rather, they have only been utilized at the location of various small loads. Such electrical architecture has typically acted much like the prior art mechanical circuit breakers in that they wait until a high limit is crossed to open. This may require seconds, and thus does require the generator and associated components to be undesirably large as mentioned.

### SUMMARY

An electrical architecture includes at least one generator. A fast switching device connects the generator to a bus. A plurality of loads draw electrical power from the bus.

These and other features of this application will be better understood from the following specification and drawings, the following of which is a brief description:

### BRIEF DESCRIPTION OF THE DRAWINGS

FIG. 1 is a schematic view of an electric architecture.

### DETAILED DESCRIPTION

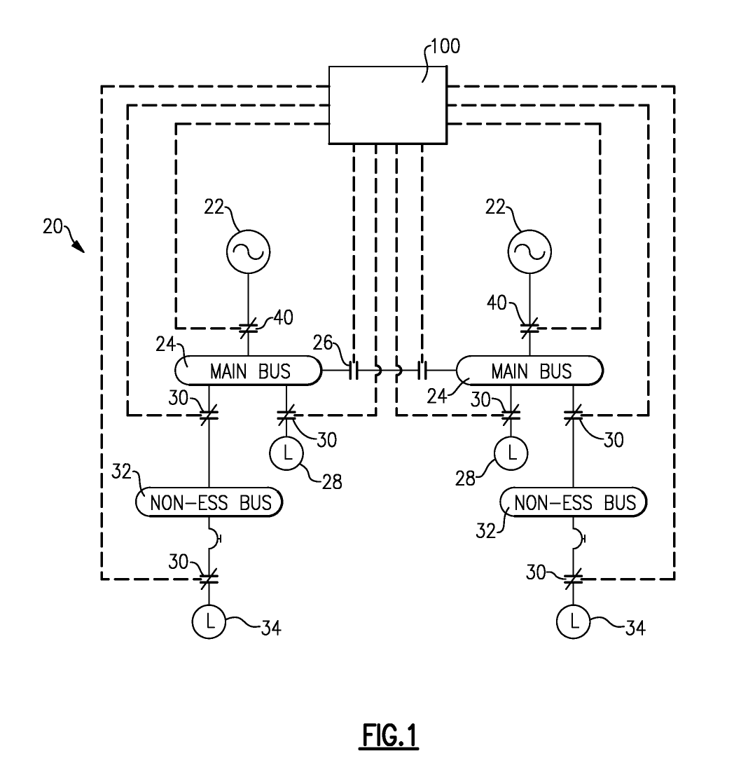

FIG. 1 shows an aircraft electric architecture 20 including generators 22 which may be associated with gas turbine engines, as known. The generators 22 supply power to main buses 24. Cross-tie switching devices 26 may either connect or disconnect the buses 24.

The buses 24 are shown connected to loads 28, and through switches 30. The switches may act as circuit breakers, and disconnect the load from the bus 24 under certain conditions, as known.

Another circuit breaker or switch 30 connects the main bus 24 to a non-essential bus 32. The non-essential bus 32 may power various systems that are not essential to continued operation of the aircraft. Another switch 30 connects the non-essential bus 32 to a load 34. In practice, there would typically be many more loads connected to both buses 24 and 32.

As shown, a switch 40 connects the generator 22 to the bus 24. This function has conventionally been provided by a mechanical switch.

However, in the present invention, the switches 40 are fast switching devices. One such fast switching device may be a solid state switching device. A second such fast switching device could be a hybrid incorporating features of both solid state and mechanical. Such switching devices may open and close at an AC wave form zero crossing. This reduces the fault current to zero. For this reason, the switches 40 are only influenced by the steady state power and a load startup inrush current, and not by the AC fault current.

In addition, such switches can transition to open or closed states in an extremely short period of time. As an example, it is possible for such switches to transition in less than one millisecond. Switches 30, and cross-tie switching devices 26 may also be solid state switching devices.

In the new architecture, a control 100 for the overall system may receive signals from the switches 26, 30, and 40. Each of the distinct locations have distinct expected profiles that the switches may experience. This may relate to a current, to a change in current, to a voltage, or to any number of other electrical features. That is, each of the locations, dependent on the loads they are powering, or the buses they are supplying, would have an expected signal profile. The control 100 is provided with the expected profile, and also a series of conditions that would likely exist at that location for that switch in the event of an upcoming fault. The control 100 is thus operable to compare received signals with expected profiles and immediately open the particular switch associated with the fault should the two signals differ by more than a predetermined amount.

Once this occurs, the generators need not supply unduly high power, and much smaller generators 22 may be incorporated into the architecture. Similarly, the switches, wires, etc. may all be made smaller as none of them will be required to handle the overcurrents as are currently found in the prior art.

The above features enable the generator and its associated distribution components to be sized according to the steady state and load inrush current, instead of a fault clearing condition. As an example, it is anticipated that a generator with the inventive architecture could be 15-25% the size of a generator used in comparable prior art electric architectures. Further, the wiring, cross tie devices, and other load protection systems can also all be made correspondingly smaller.

Although an embodiment of this invention has been disclosed, a worker of ordinary skill in the art would recognize that certain modifications would come within the scope of this invention. For that reason, the following claims should be studied to determine the true scope and content of this invention.

What is claimed is:

1. An electrical architecture comprising;
at least one generator;
a fast main switching device connecting said generator to a main bus; and
a plurality of loads drawing electrical power from said main bus.

2. The electrical architecture as set forth in claim 1, wherein said fast main switching device is a main solid state switching device.

3. The electrical architecture as set forth in claim 2, wherein the entire current flow from the generator passes through the solid state switching device and to the main bus.

4. The electrical architecture as set forth in claim 2, wherein at least some of the loads are connected to the main bus through load solid state switching devices.

5. The electrical architecture as set forth in claim 2, wherein said main bus also communicates power to a non-essential bus, with said non-essential bus driving a plurality of loads.

6. The electrical architecture as set forth in claim 2, wherein there are at least two of said generators, each of said at least two generators communicating to a separate main bus through a separate solid state switching device.

7. The electrical architecture as set forth in claim 6, wherein cross-tie switching devices connect said main buses such that they can be connected or disconnected.

8. The electrical architecture as set forth in claim 2, wherein said main solid state switching device opens and closes at an AC wave form zero crossing.

9. The electrical architecture as set forth in claim 2, wherein said electrical architecture is for use on an aircraft.

10. The electrical architecture as set forth in claim 2, wherein a control receives a signal with regard to conditions at the main solid state switching device, and said control comparing said signal to expected conditions, and sending a control signal to open said main solid state switching device if said signal differs from said expected conditions by a predetermined amount.

11. The electrical architecture as set forth in claim 10, wherein said control also receives signals from a plurality of other solid state switching devices associated with the architecture, and compares said signals to expected conditions at the location of each of said plurality of solid state switching devices, and opens any one of said plurality of solid state switching devices which is associated with a potential fault based upon said comparison.

12. An electrical architecture for use on an aircraft comprising:
at least two generators, with each of said generators communicating to a separate main bus; and
said generators connected to the respective main buses through main solid state switching devices, such that the entire current flow from each of the generators passes through the respective main switching device and to the main bus;, and
a control receiving signals with regard to the condition at the respective main solid state switching devices, and said control comparing said signal to expected conditions at said respective main switching devices, and said control comparing said signal to expected conditions, and said control opening any one of said main switching devices which is potentially experiencing a fault condition based upon the comparison of said signal to said expected conditions.

13. The electrical architecture as set forth in claim 12, wherein said main switching device is a solid state switching device.

14. The electrical architecture as set forth in claim 13, wherein at least some of a plurality of loads are connected to the main buses through load solid state switching devices, and said control also receiving a signal from said load solid state switching devices and comparing said signal from said load solid state switching devices to expected conditions, and opening any one of said load solid state switching devices which appears to be experiencing a fault based upon said comparison.

15. The electrical architecture as set forth in claim 13, wherein said main buses also communicate power to non-essential buses, with said non-essential buses driving a plurality of loads.

16. The electrical architecture as set forth in claim 13, wherein cross-tie switching devices connect said main buses such that they can be connected or disconnected and said control also receiving a signal from said cross-tie switching devices and comparing said signal from said cross-tie switching devices to expected conditions, and opening any one of said cross-tie switching devices which appears to be experiencing a fault based upon said comparison.

17. An electrical architecture for use on an aircraft comprising:
at least two generators, with each of said generators communicating through a separate main bus;
said generators connected to said respective main buses through main switching devices, such that the entire current flow from each of the generators passes through the respective main switching devices and to the main bus;
wherein at least some of a plurality of loads are connected to the main buses through load solid state switching devices, said main buses also communicating power to non-essential buses, with said non-essential buses driving a plurality of loads;
cross-tie switching devices connecting said main buses to each other such that they can be connected or disconnected;
a control receiving a signal with regard to the power at the main solid state switching device, and said control comparing said signal to expected conditions, and sending a control signal to open said main solid state switching device if said signal differs from said expected conditions by a predetermined amount; and
said control also receiving signals from said load and cross-tie solid state switching devices, and compares said signals to expected signals at the location of each of said load and cross-tie solid state switching devices, and opens any one of said load and cross-tie solid state switching devices which is associated with a potential fault.

18. The electrical architecture as set forth in claim 17, wherein said main switching devices are solid state switching devices.
